(19) United States
(12) Patent Application Publication
(10) Pub. No.: US 2016/0001611 A1
(43) Pub. Date: Jan. 7, 2016

(54) Self-Sealing Tire Comprising An Additional Sidewall Reinforcement

(71) Applicants: CAMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventor: Olivier MUHLHOFF, Clermont-Ferrand Cedex 9 (FR)

(21) Appl. No.: 14/769,001

(22) PCT Filed: Feb. 21, 2014
(86) PCT No.: PCT/EP2014/053392

§ 371 Date: Aug. 19, 2015

(30) Foreign Application Priority Data
Feb. 25, 2013 (FR) 1351611

(51) Int. Cl. B60C 17/10; B60C 9/00; B60C 13/00; B60C 15/00; B60C 9/02; B60C 9/18

(52) U.S. Cl. CPC B60C 17/106; B60C 9/02; B60C 9/18; B60C 13/00; B60C 15/0009; B60C 9/0042; B60C 9/005

(57) ABSTRACT

Tire, the internal wall of which is covered with an airtight layer, itself covered with a layer of self-sealing product, comprising a radial carcass reinforcement (60) composed of reinforcing elements (61) having an elongation at break EB_{C} and a breaking strength BS_{C}, placed at a placement pitch P_{C} and coated with rubber composition, designed so as to satisfy the inequality:

$$\frac{{BS}_{C}}{{P}_{C}} \leq 1.5 \cdot {10}^{6} \cdot \frac{( {R}_{S}^{2} - {R}_{E}^{2} )}{{R}_{T}} .$$

Each sidewall of the tire additionally comprises an additional strengthening reinforcement (120) composed of thread reinforcing elements having an elongation at break EB_{A} and a breaking strength BS_{A}, placed at a placement pitch P_{A} and coated with rubber composition, in which each of the two additional strengthening reinforcements is designed such that:

$$\frac{{BS}_{A}}{{P}_{A}} \geq 1.3 \cdot \frac{{BS}_{C}}{{P}_{C}} ,$$

and EB_{C}≧EB_{A}, the breaking strengths BS_{A} and BS_{C} and the elongations at break EB_{C} and EB_{A} being determined on the reinforcing elements before their incorporation in the tire.

### FIELD OF THE INVENTION

The present invention relates to tires for vehicles comprising textile carcass reinforcements. It relates more particularly to the carcass reinforcements of these tires and in particular to the carcass reinforcements of tires suitable for providing extended mobility to the vehicle which is equipped with them.

### BACKGROUND

During its life, a tire experiences a large number of assaults of different natures, such as, for example, perforations or violent impacts.

During a perforation of the wall of a tire by a perforating object, such as a screw or a nail, or “puncture”, the inflating air of the tire can escape via the perforation and the resulting loss in pressure can result in a flattening of the tire and in the halting of the vehicle.

The normal solution, in order to solve this problem of punctures, which dates from the very beginning of the use of road wheels having inflated tires, is to stop and to replace the wheel concerned with a spare wheel.

Other solutions have been devised and are available on the market in order to avoid having to use a spare wheel.

The document U.S. Pat. No. 5,916,921 presents an aerosol container comprising an aqueous latex emulsion mixed with various products, including fibrous products, and a propellant gas. In the event of a flat tire, this container is designed to be attached to the valve of the tire and to send the propellant gas and the sealing/repair emulsion into the internal cavity of the tire. The tire is then at least partially reinflated, the emulsion plugs the perforation and it is possible to start running again, first at reduced speed, in order to thoroughly distribute the emulsion over the entire internal surface of the tire, and then normally.

There also exist repair kits, provided by some motor vehicle manufacturers instead of a spare wheel. This has the advantage of reducing the weight of the car, and thus its fuel consumption, and of freeing space under the floor of the boot.

Repair kits for tires and aerosol cans are only temporary repairs. It is advisable not to exceed a given speed of the order of 80 km/h and to inspect or quickly change its tire.

Type manufacturers have also proposed tires provided, on their interior wall or in their structure, with a layer of elastic, viscous or pasty products, known as “self-sealing products”, which make it possible to seal off the perforations. The document WO 2008/080556 A1 presents an example of such a tire. These tires are not puncture-proof as such but the perforations are normally reclosed or sealed by the self-sealing product. In comparison with the puncture-combating cans or kits, these tires equipped with a layer of self-sealing product have the advantage of not requiring that the vehicle be halted. On the other hand, when the perforating objects are excessively large in size or when the perforations are located outside the regions facing the layers of self-sealing products, these tires do not deal with the problem of punctures.

Tire manufacturers have also devised the introduction, into the entire combined tire/wheel, of structural reinforcing elements which allow the tire to continue to run in the event of a loss in pressure related to a puncture. These reinforcing elements can be placed in the structure of the tire, as in the document WO 2002/030689 A1 (reference is then made to self-supporting tire) or can constitute a support, as proposed in the document EP 0 673 324 B1. Self-supporting tires and supports allow a vehicle equipped with them to continue to run, at least over a limited distance and at reduced speed, whatever the seriousness of the puncture. On the other hand, these solutions are expensive and result, during normal use of the vehicle, in a deterioration in some of the performance factors of the tires, such as the comfort or the rolling resistance.

However, perforation is not the only means of damage to a tire running along a road. The tire can in particular experience impacts at the tread or sidewalls, the frequency and the intensity of which are often considerable. It is one of the main functions of a tire to absorb these impacts and to cushion them, without the wheel of the vehicle concerned being substantially affected by them, either in its movement or in its integrity.

However, it happens that this property of absorbing punishment meets its limits when the impact conditions are such that the wall of the impacted casing comes into abutment inside the tire chamber either directly against the rim on which the tire is fitted or, more usually, against another region of the wall of the casing, itself directly supported on the wheel rim. This is in particular the case when the rim exhibits an external radial projection with respect to the seat proper. Such a projection (normally called “rim flange”) is generally designed to prevent the tire bead from coming off its rim under the effect of axial directional stresses during the manoeuvres of the wheel.

The impact with the obstacle may then transmit brief but very intense loads, which can in some cases reach several tonnes, to the abutted parts but also, beyond the rim, to the mechanical suspension attachments of the wheel assembly, indeed even to the body of the vehicle. They are capable of creating serious damage on the components of the suspension and of permanently deforming the body of the vehicle. Vehicle designers are thus led to provide sufficient absorption systems to prevent this damage and to design the body of the vehicles as a function of the extreme cases normally foreseeable.

Unfortunately, even when the vehicle proper is suitably protected, the tire subjected to this type of incident is capable of suffering from the consequences of the phenomenon which has just been mentioned. In the section impacted by the impact, the internal wall of the tire is suddenly folded and pinched between the obstacle and the rim flange (pinch shock). This can cause the wall to rupture and the tire loses its inflation pressure, which, most of the time, involves the immediate immobilization of the vehicle. However, even when the tire withstands this, its components may have been damaged by the incident; bulges in the sidewalls or other signs indicate to the expert that the structure of the casing has been weakened and that there is a risk of its wall rupturing under the effect of the repeated bending of its components, in the more or less long term.

Several avenues have been proposed for reinforcing the tires with respect to this pinch shock phenomenon. In the majority of these tires, the carcass reinforcement is anchored in the bead via a turn-up around an annular reinforcing structure provided in the bead. The carcass reinforcement then comprises an “outward strand”, which extends from one bead to the other, passing through the crown of the tire, and two “return strands” which extend from the annular reinforcing structure radially towards the outside. In order to reinforce a tire with respect to pinch shock, it is known in particular to extend the “return strands” of the carcass reinforcement so that their radially exterior end is sandwiched between the “outward strand” of the carcass reinforcement and the crown reinforcement. This configuration is known under the name of shoulder lock.

While an architecture of the shoulder lock type indeed makes it possible to render the tire less vulnerable with respect to pinch shock, it comprises the disadvantage of being expensive while not making possible very fine adjustment of the performance of the tire. In addition, this solution magnifies the problems of nonuniformity related to the welds of the ply forming the carcass reinforcement as a weld is necessarily located at the same point for the outward strand and the return strand.

### SUMMARY OF THE INVENTION

One of the objectives of the present invention is to respond to these concerns and to define a tire which withstands both the harmful effects of a perforation and the pinch shock phenomenon while making possible fine adjustment of its performance factors and good uniformity.

This objective is achieved by a tire provided with a layer of self-sealing product and combining an “under-designed” carcass reinforcement, that is to say designed so that it cannot, by itself alone, under all the conditions of use reasonably foreseeable, fulfill all the functions of a carcass reinforcement (withstand the inflation pressure, carry the filler, absorb the impacts), and an appropriate additional strengthening reinforcement. The functions of the carcass reinforcement are thus provided by the combination of the carcass reinforcement proper and of the additional strengthening reinforcement, which makes it possible to separately optimize each of these reinforcements and to obtain an improved performance/cost price ratio.

More specifically, the objective is achieved by a tire in the form of a torus having an internal wall and an external wall, the internal wall being, at least in part, covered with an airtight layer, the tire having an axis of rotation and comprising:
two beads intended to come into contact with a mounting rim, each bead comprising at least one annular reinforcing structure having a radially innermost point,
two sidewalls extending the beads radially outwards, the two sidewalls coming together in a crown comprising a crown reinforcement, radially surmounted by a tread;
a radial carcass reinforcement composed of thread reinforcing elements having an elongation at break EB_{C} and a breaking strength BS_{C}, placed at a placement pitch P_{C} and coated with rubber composition, the carcass reinforcement extending from one bead to the other, passing through the crown, the carcass reinforcement being anchored in each bead by a turn-up around the said at least one annular reinforcing structure, so as to form an outward strand and a return strand, the carcass reinforcement being designed so as to satisfy the inequality:

$$\frac{{BS}_{C}}{{P}_{C}} \leq 1.5 \cdot {10}^{6} \cdot \frac{( {R}_{S}^{2} - {R}_{E}^{2} )}{{R}_{T}} ,$$

where BS_{C} is expressed in newtons, R_{S} is the radial distance between the axis of rotation of the tire and the radially outermost point of the carcass reinforcement, R_{E} is the radial distance between the axis of rotation of the tire and the axial position where the tire reaches its maximum axial width, and R_{T} is the radial distance between the axis of rotation of the tire and the radially innermost point of the said at least one annular reinforcing structure, the placement pitch P_{C} and the radial distances R_{S}, R_{E} and R_{T} being expressed in metres;
each sidewall of the tire additionally comprising an additional strengthening reinforcement composed of thread reinforcing elements having an elongation at break EB_{A} and a breaking strength BS_{A}, placed at a placement pitch P_{A} and coated with a rubber composition, the additional strengthening reinforcement extending between a radially internal end occurring close to the said at least one annular reinforcing structure of the bead which extends the sidewall and a radially external end located radially between the carcass reinforcement and the crown reinforcement,
   in which EB_{A}, BS_{A}, P_{A}, EB_{C}, BS_{C} and P_{C} are chosen such that

$$\frac{{BS}_{A}}{{P}_{A}} \geq 1.3 \cdot \frac{{BS}_{C}}{{P}_{C}} , \\ and$$

$${EB}_{C} \geq {EB}_{A} ,$$

it being specified that the breaking strengths BS_{A} and BS_{C} and the elongations at break EB_{C} and EB_{A} are the corresponding values of the reinforcing elements before their incorporation in the tire.
the said airtight layer being, at least in part, covered with a layer of self-sealing product.

This is because the combination of a “under-designed” carcass reinforcement and of an additional strengthening reinforcement makes it possible to reduce the cost and the weight of the tire and to increase the sturdiness thereof, while giving increased flexibility to the designer. The tire according to the invention combines this specific architecture with the presence of a layer of self-sealing product, which allows it to better withstand the harmful effects of a perforation. In other words, the very great majority of punctures will have no consequence with regard to the internal inflation pressure. In the case where this layer does not make it possible to prevent the loss in pressure of the tire, it has been found that the presence of this layer makes it possible to significantly increase the distance which the tire can travel when running flat while retaining the possibility of driving the vehicle since the beads remain in place on the seats of the rim. This is because the presence of this layer of self-sealing product makes it possible to delay the damage to the sidewalls of the tire by a lubricating effect in particular. This tire thus allows the vehicle, whatever the seriousness of a perforation or puncture, to continue to run for at least several kilometres, which allows it to leave a dangerous area. This is obtained without any deterioration in the performance factors of comfort, of rolling resistance or of behaviour in normal use.

The invention makes it possible to strengthen the carcass reinforcement at the point where it is highly stressed (that is to say, in the sidewalls) while reducing its resistance (and consequently its cost) in the region where it is only slightly stressed (that is to say, in the crown), in contrast to the shoulder lock, which simply increases the carcass reinforcement in the sidewall. The invention is thus more advantageous in proportion as the sidewall shortens and the crown broadens.

According to a first preferred embodiment, the crown reinforcement has, in each radial cross section, two axial ends and the radially external end of each of the two additional strengthening reinforcements is axially inside the axial end of the closest crown reinforcement, the axial distance between the radially external end of each additional strengthening reinforcement and the axial end of the closest crown reinforcement being greater than or equal to 10 mm. Thus, the reinforcement is well anchored under the crown reinforcement, which allows it to take up the tensions well and to relieve the strain on the carcass reinforcement proper.

According to a second preferred embodiment, the radially interior end of each additional strengthening reinforcement is radially inside the radially outermost point of the return strand of the carcass reinforcement and the radial distance DR between the radially interior end of each additional strengthening reinforcement and the radially outermost point of the return strand of the carcass reinforcement is greater than or equal to 10 mm. This makes possible good anchoring of the additional strengthening reinforcement in the bead and, consequently, makes it possible to take up the tensions well by the additional strengthening reinforcement.

According to a specific embodiment, each additional strengthening reinforcement extends, in the bead, along the outward strand of the carcass reinforcement. This configuration has the advantage of great simplicity of placement when the tire is made.

Conventionally, tires are made by the placement of plies on a drum, in which case the carcass reinforcement and the additional strengthening reinforcement each comprise at least one lap weld. According to a specific embodiment, the weld of the carcass reinforcement is offset, in the circumferential direction, with respect to the weld of the additional strengthening reinforcement. This embodiment, which cannot be achieved in an architecture of the shoulder lock type, makes it possible to improve the uniformity of the tire.

According to an alternative embodiment, each additional strengthening reinforcement extends, in the bead, along the return strand of the carcass reinforcement. Thus, any contact between the additional strengthening reinforcement and the annular reinforcing structure is certain to be avoided, even when the length of the additional strengthening reinforcement is too great.

According to a specific embodiment, the reinforcing elements of each additional strengthening reinforcement are oriented radially. This design makes it possible to retain the overall compromise in performance related to the radial structure of the carcass reinforcement (comfort, rolling resistance, behaviour, and the like compromise) while improving the pinch shock performance.

According to another specific embodiment, the reinforcing elements of each additional strengthening reinforcement are inclined at an angle of between 40° and 80° and preferably between 40° and 50°, with respect to the radial direction. This design makes it possible to increase the vertical stiffness, which is beneficial for the pinch shock performance, while also orienting the reinforcing elements so as to promote the absorption of longitudinal tensions, which makes it possible to improve their resistance to pavement impacts.

It is possible in particular to make the reinforcing elements of the additional strengthening reinforcement of PET, of aramid, of aramid/nylon hybrid cords or of aramid/PET hybrid cords. Reinforcing elements made of aramid or of hybrid cords are rarely used in the carcass reinforcement as they do not withstand compression very well. In point of fact, the carcass reinforcement is often subjected to compression, in particular in tires having short sidewalls. On the other hand, the additional strengthening reinforcement is subjected less to compression, which makes it possible to use these reinforcing elements, which are distinguished by their tenacity. The specific advantage of the aramid/nylon hybrid cords lies in their high breaking strength, and the advantage of the aramid/PET hybrid cords is that of benefiting from the qualities of the aramid while having the stiffness of PET reinforcers.

According to a specific embodiment, the layer of self-sealing product is positioned on the airtight layer facing the crown.

Advantageously, the layer of self-sealing product extends over the airtight layer facing at least a portion of the sidewalls, so that, in each sidewall, the radially innermost point of the layer of self-sealing product occurs radially inside the radially external end of the additional strengthening reinforcement.

The layer of self-sealing product can comprise at least one thermoplastic stirene (“TPS”) elastomer and more than 200 phr of an extending oil for the said elastomer, “phr” meaning parts by weight per hundred parts of solid elastomer.

The TPS can be the predominant elastomer of the layer of self-sealing product.

The TPS elastomer can be selected from the group consisting of stirene/butadiene/stirene (SBS), stirene/isoprene/stirene (SIS), stirene/isoprene/butadiene/stirene (SIBS), stirene/ethylene/butylene/stirene (SEBS), stirene/ethylene/propylene/stirene (SEPS) and stirene/ethylene/ethylene-/propylene/stirene (SEEPS) block copolymers and the mixtures of these copolymers.

Advantageously, the TPS elastomer is selected from the group consisting of SEBS copolymers, SEPS copolymers and the mixtures of these copolymers.

According to another embodiment, the layer of self-sealing product can comprise at least (phr meaning parts by weight per hundred parts of solid elastomer):
(a) as predominant elastomer, an unsaturated diene elastomer;
(b) between 30 and 90 phr of a hydrocarbon resin;
(c) a liquid plasticizer, the Tg (glass transition temperature) of which is less than −20° C., at a content by weight of between 0 and 60 phr; and
(d) from 0 to less than 120 phr of a filler.

The unsaturated diene elastomer is advantageously selected from the group consisting of polybutadienes, natural rubber, synthetic polyisoprenes, butadiene copolymers, isoprene copolymers and the mixtures of such elastomers.

The unsaturated diene elastomer can advantageously be an isoprene elastomer, preferably selected from the group consisting of natural rubber, synthetic polyisoprenes and the mixtures of such elastomers.

Advantageously, the content of unsaturated diene elastomer is greater than 50 phr, preferably greater than 70 phr.

Of course, it is possible (and can even be advantageous) to combine several of these embodiments in order to obtain a particularly high performance tire.

The invention as described above relates to tires having a turn-up of the carcass reinforcement around an annular reinforcing structure. Of course, it would be possible to provide an additional strengthening reinforcement as described in a tire in which the reinforcement is anchored between a plurality of annular reinforcing structures, such as, for example, the architectures obtained in the “C3M” process of Michelin, which are well known to a person skilled in the art.

A subject-matter of the invention is also an assembly comprising a wheel and a tire as described above, such that it additionally comprises a device for measuring the inflation pressure of the internal cavity of the wheel and tire assembly.

With such an assembly, cases of loss of inflation pressure become very rare and, furthermore, in such a case, the loss of pressure is generally very slow. The device for measuring the inflation pressure makes it possible to warn sufficiently soon to repair the tire or to change it before the inflation pressure becomes too low and thus before any damage to the structure of the tire.

Such a device can be a pressure sensor attached to the valve of the wheel or to the internal surface of the tire or also placed in the structure of the tire.

### BRIEF DESCRIPTION OF THE DRAWINGS

FIG. 1 represents a tire according to the prior art.

FIG. 2 represents a partial view in perspective of a tire according to the prior art.

FIG. 3 represents, in radial cross section, a portion of a reference tire.

FIG. 4 represents, in radial cross section, a portion of a reference tire having a shoulder lock configuration.

FIGS. 5 and 7 represent, in radial cross section, a portion of a tire according to the invention.

FIG. 6 illustrates the distribution of the tensions between the carcass reinforcement and the additional strengthening reinforcement, at the sidewall.

FIG. 8 illustrates certain quantities used to characterize a tire according to the invention.

FIG. 9 exhibits an example of an extrusion/compounding device which can be used for the manufacture of a self-sealing product composition.

### DETAILED DESCRIPTION OF THE FIGURES

In the use of the term “radial”, it is advisable to distinguish several different uses of the word by a person skilled in the art. First, the expression refers to a radius of the tire. It is within this meaning that it is said, of a point P1, that it is “radially interior to” a point P2 (or “radially inside” the point P2) if it is closer to the axis of rotation of the tire than the point P2. Conversely, a point P3 is said to be “radially exterior to” a point P4 (or “radially outside” the point P4) if it is further from the axis of rotation of the tire than the point P4. It will be said that a movement is “radially inwards (or outwards)” when the movement is in the direction of the shortest (or longest) radii. When it is a question of radial distances, this meaning of the term also applies.

On the other hand, a thread or a reinforcement is said to be “radial” when the thread or the reinforcing elements of the reinforcement form, with the circumferential direction, an angle of greater than or equal to 80° and less than or equal to 90°. It should be specified that, in the present document, the term “thread” should be understood in an entirely general sense and comprises the threads provided in the form of monofilaments, of multifilaments, of a cord, of folded yarns or of an equivalent assemblage, this being the case whatever the material forming the thread or the surface treatment for promoting the bonding thereof with the rubber.

Finally, the term “radial cross section” is understood here to mean a cross section along a plane which comprises the axis of rotation of the tire.

An “axial” direction is a direction parallel to the axis of rotation of the tire. A point P5 is said to be “axially interior to” a point P6 (or “axially inside” the point P6) if it is closer to the median plane of the tire than the point P6. Conversely, a point P7 is said to be “axially exterior to” a point P8 (or “axially outside” the point P8) if it is further from the median plane of the tire than the point P8. The “median plane” of the tire is the plane which is perpendicular to the axis of rotation of the tire and which is located equidistantly from the annular reinforcing structures of each bead.

A “circumferential direction” is a direction which is perpendicular both to a radius of the tire and to the axial direction.

In the context of this document, the expression “rubber composition” denotes a composition formed of rubber comprising at least one elastomer and one filler.

### I. Architecture of the Tires

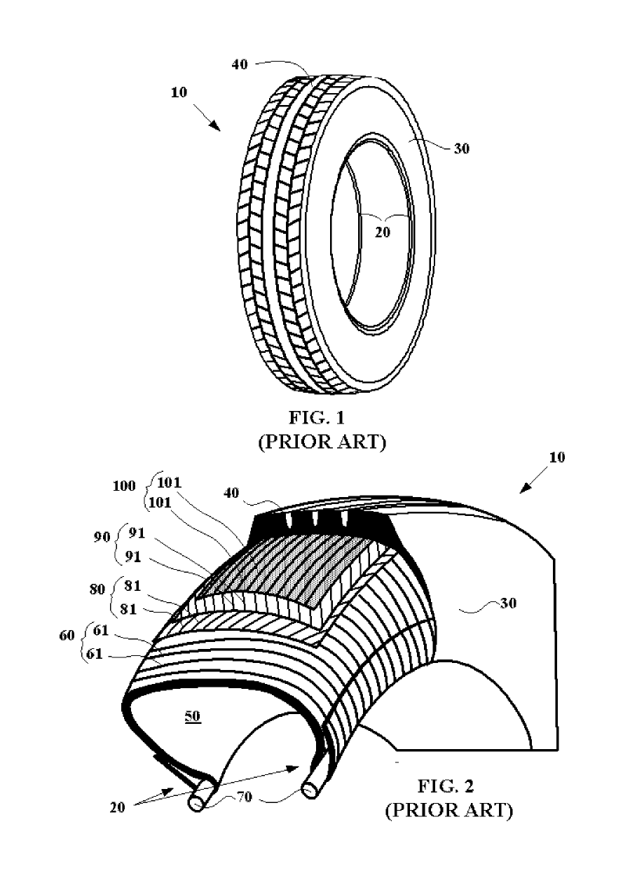

FIG. 1 diagrammatically represents a tire 10 according to the prior art. The tire 10 comprises a crown comprising a crown reinforcement (invisible in FIG. 1) surmounted by a tread 40, two sidewalls 30 which extend the crown radially inwards and two beads 20 radially interior to the sidewalls 30.

FIG. 2 diagrammatically represents a partial view in perspective of a tire 10 according to the prior art and illustrates the various components of the tire. The tire 10 comprises a carcass reinforcement 60 composed of threads 61 coated with rubber composition, and two beads 20 each comprising annular reinforcing structures 70 which hold the tire 10 on the rim (not represented). The carcass reinforcement 60 is anchored in each of the beads 20 by a turn-up. The tire 10 additionally comprises a crown reinforcement comprising two plies 80 and 90. Each of the plies 80 and 90 is reinforced by thread reinforcing elements 81 and 91 which are parallel in each layer and cross from one layer to the other, forming angles of between 10° and 70° with the circumferential direction. The tire also comprises a hoop reinforcement 100, positioned radially outside the crown reinforcement, this hoop reinforcement being formed of reinforcing elements 101 oriented circumferentially and wound into a spiral. A tread 40 is placed on the hoop reinforcement; it is this tread 40 which provides the contact of the tire 10 with the road. The tire 10 represented is a tubeless tire: it comprises an “inner liner” 50 made of butyl-based rubber composition, impermeable to the inflating gas, covering the interior surface of the tire.

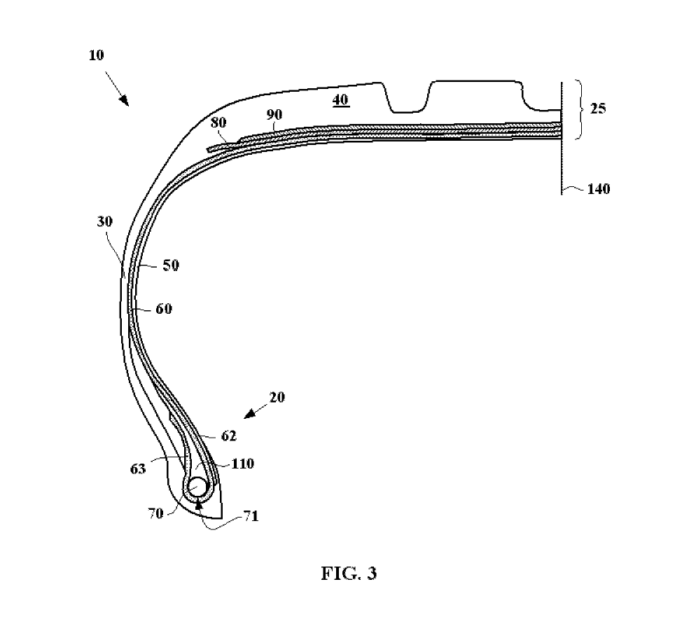

FIG. 3 represents, in radial cross section, half of a reference tire. This tire has an axis of rotation (not represented) and comprises two beads 20 intended to come into contact with a mounting rim (not represented). Each bead comprises an annular reinforcing structure, in this case a bead wire 70. The radially innermost point of the bead wire carries the reference 71.

The tire comprises two sidewalls 30 which extend the beads radially outwards, the two sidewalls 30 coming together in a crown 25 comprising a crown reinforcement formed by the plies 80 and 90. The crown reinforcement is surmounted by a tread 40. In principle, it would be possible to also provide a hoop reinforcement, such as the hoop reinforcement 100 of the tire represented in FIG. 2, but, in this case, an attempt has been made to minimize the weight of the tire by not providing a hoop reinforcement.

The tire comprises just one radial carcass reinforcement 60 extending from the beads 20 across the sidewalls 30 up to the crown, the carcass reinforcement 60 comprising a plurality of carcass reinforcing elements. It is anchored in the two beads 20 by a turn-up around the bead wire 70, so as to form an outward strand 62 and a return strand 63. The filling 110, formed of a rubber composition, fills the volume between the outward strand 62 and the return strand 63.

The median plane of the tire is indicated using the reference 140.

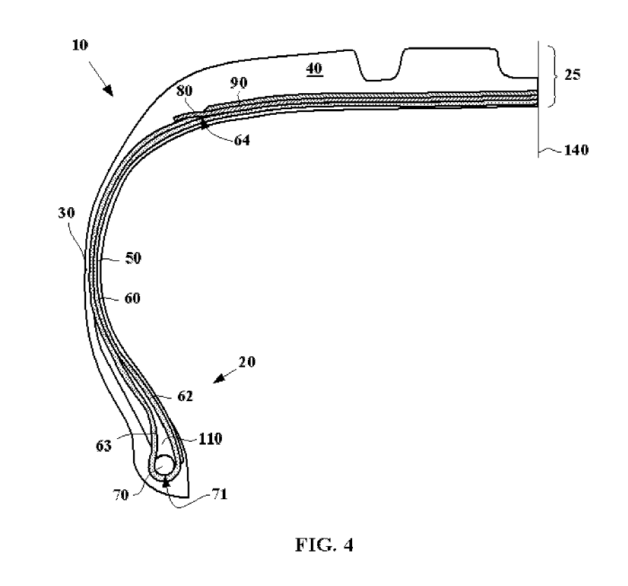

FIG. 4 represents, in radial cross section, a portion of another reference tire having a shoulder lock configuration. Unlike the tire represented in FIG. 3, the return strand 63 does not terminate in the bead but extends as far as the crown. Its radially exterior end 64 is housed between the ply 80 of the crown reinforcement and the outward strand 62 of the carcass reinforcement. Thus, the carcass reinforcement 60 is doubled in thickness throughout the bead 20 and the sidewall 30, which significantly increases the resistance of the tire to assaults of pinch shock type.

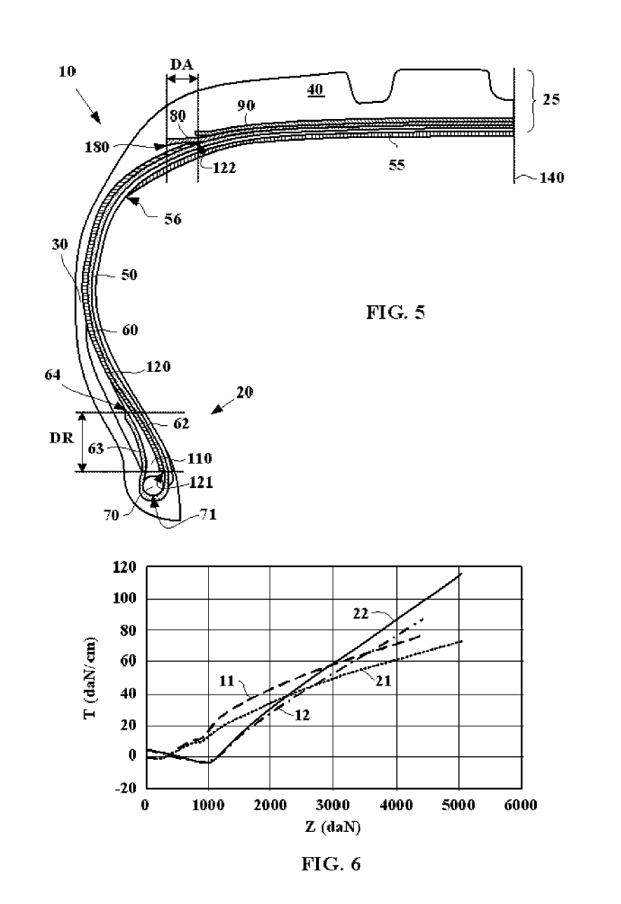

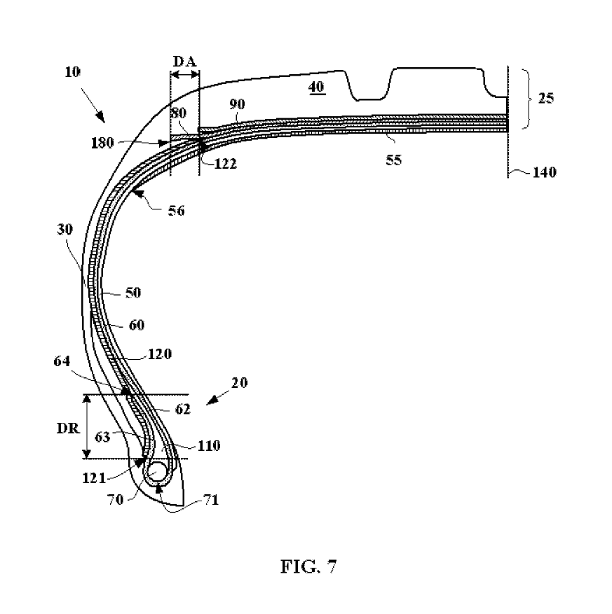

The disadvantage of this architecture is that it is expensive—because it requires the use of the same reinforcement in the sidewalls and in the crown, while it is possible to lighten the carcass reinforcement in the crown—while not making possible very fine adjustment of the performance of the tire. The tire according to the invention, two embodiments of which are represented in FIGS. 5 and 7, makes it possible to overcome these disadvantages.

The tire according to the invention of FIG. 5 comprises two beads 20 (only one of which is represented) intended to come into contact with a mounting rim (not represented). Each bead comprises an annular reinforcing structure, in this case a bead wire 70, having a radially innermost point 71. It also comprises two sidewalls 30 which extend the beads 20 radially outwards, the two sidewalls coming together in a crown 25 comprising a crown reinforcement, formed by the two plies 80 and 90 and radially surmounted by a tread 40. A radial carcass reinforcement 60, composed of thread reinforcing elements having an elongation at break EB_{C} and a breaking strength BS_{C} and coated with rubber composition, extends from one bead 20 to the other, passing through the crown 25. The carcass reinforcement 60 is anchored in each bead 20 by a turn-up around the bead wire 70, so as to form an outward strand 62 and a return strand 63. It is designed so as to satisfy the inequality:

$$\frac{{BS}_{C}}{{P}_{C}} \leq 1.5 \cdot {10}^{6} \cdot \frac{( {R}_{S}^{2} - {R}_{E}^{2} )}{{R}_{T}} .$$

P_{C} is the placement pitch of the reinforcing elements of the carcass reinforcement (that is to say, 1 divided by the number of reinforcing elements per metre and thus expressed in metres) in the vicinity of the bead wire 70; the breaking strength BS_{C} is expressed in newtons.

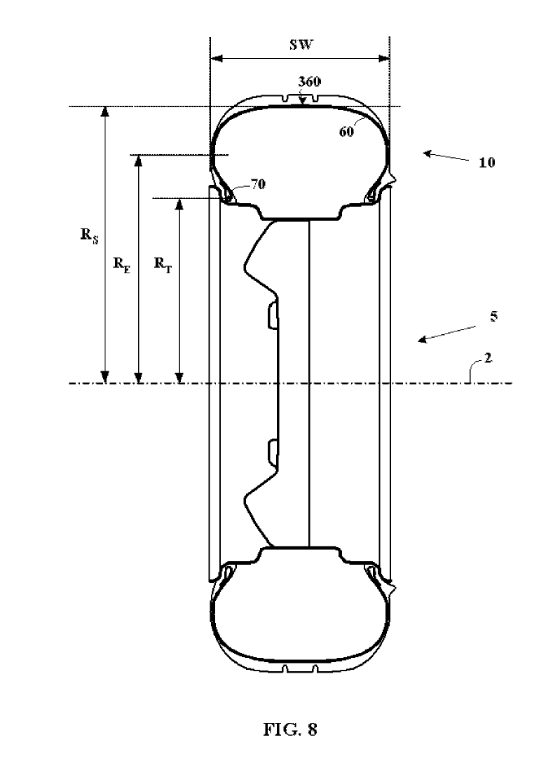

The meanings of the parameters R_{S}, R_{E} and R_{T} are illustrated in FIG. 8. R_{S} is the radial distance between the axis of rotation 2 of the tire 10 and the radially outermost point 360 of the carcass reinforcement 60, R_{E} is the radial distance between the axis of rotation 2 and the axial position where the tire reaches its maximum axial width SW, and R_{T} is the radial distance between the axis of rotation 2 and the radially innermost point 71 of the bead wire 70 (indicated in FIG. 5). The radial distances R_{S}, R_{E} and R_{T} are expressed in meters.

As is suggested in FIG. 5, each sidewall 30 of the tire 10 according to the invention comprises an additional strengthening reinforcement 120 composed of thread reinforcing elements having an elongation at break EB_{A} and a breaking strength BS_{A}, placed at a placement pitch P_{A} and coated with rubber composition, the additional strengthening reinforcement extending between a radially interior end 121 occurring close to the bead wire 70 and a radially exterior end 122 located radially between the carcass reinforcement and the crown reinforcement. BS_{A}, P_{A}, BS_{C} and P_{C} are chosen such that:

$$\frac{{BS}_{A}}{{P}_{A}} \geq 1.3 \cdot \frac{{BS}_{C}}{{P}_{C}} .$$

This difference in breaking strength can be obtained by various means known per se to a person skilled in the art. It is possible to vary in particular the count, twist, material or even heat treatment undergone by the reinforcing elements in order to obtain the required difference.

The elongation at break EB_{C} of the reinforcing elements of the carcass reinforcement is greater than or equal to the elongation at break EB_{A} of the reinforcing elements of each of the additional strengthening reinforcements (EB_{C}≧EB_{A}).

The breaking strengths BS_{A} and BS_{C} and the elongations at break EB_{C} and EB_{A} are the corresponding values of the reinforcing elements before their incorporation in the tire.

Before measuring, the reinforcing elements must be put through a prior condition; By prior conditioning, we mean the storage of the reinforcing elements (after drying) during at least 24 hours before the measurement, in a standard atmosphere according to the European standard DIN EN 20139 (temperature: 20±2° C.; hygrometry: 65±2%).

Subsequently, the breaking strength and elongation at break are measured, in a way well known to a person skilled in the art, using an “INSTRON” tensile testing device (see also Standard ASTM D 885-06). The samples tested are subjected to tension over an initial length L0 (in mm) at a nominal rate of L0 mm/min, under a standard pre-tension of 1 cN/tex (mean over at least 10 measurements). The breaking strength selected is the maximum force measured.

The crown reinforcement has, in each radial cross section, two axial ends 180 (only one of which is represented). The radially exterior end 122 of each of the two additional strengthening reinforcements 120 is axially inside the axial end of the closest crown reinforcement, the axial distance DA between the radially exterior end 122 of each additional strengthening reinforcement and of the axial end 180 of the closest crown reinforcement being, in this case, equal to 10 mm.

The radially interior end 121 of the additional strengthening reinforcement 120 is radially inside the radially outermost point 64 of the return strand 63 of the carcass reinforcement 60 and the radial distance DR between the radially interior end 121 of the additional strengthening reinforcement 120 and the radially outermost point 71 of the return strand 63 of the carcass reinforcement 60 is, in this case, equal to 16 mm.

In the tire according to the invention represented in FIG. 5, each additional strengthening reinforcement 120 extends, in the bead 20, along the outward strand 62 of the carcass reinforcement 60. This is not an essential characteristic of the invention; it is perfectly possible to provide for each additional strengthening reinforcement 120 to extend, in the bead 20, along the return strand 63 of the carcass reinforcement, as is represented in FIG. 7.

In the tires represented in FIGS. 5 and 7, the reinforcing elements of each additional strengthening reinforcement 120 are oriented radially but it is also possible to use additional strengthening reinforcements 120 having reinforcing elements which are inclined at an angle of between 40° and 80° and preferably between 40° and 50° with respect to the radial direction.

The reinforcing elements of the additional strengthening reinforcement 120 of the tires represented in FIGS. 5 and 7 are made of PET but other choices are possible, such as, for example, cords made of aramid, aramid/nylon hybrid cords or even aramid/PET hybrid cords.

The tires represented in FIGS. 5 and 7 comprise a layer 55 of self-sealing product positioned over a portion of the inner liner 50. In both individual cases, the layer 55 of self-sealing product is placed facing the crown 25 of the tire and extends axially over a portion of the sidewalls 30, so that, in each sidewall, the radially innermost point 56 of the layer 55 of self-sealing product occurs radially inside the radially exterior end 122 of the additional strengthening reinforcement 120, but it is perfectly possible to cover the entire inner liner with self-sealing product. This layer 55 of self-sealing product makes it possible to treat most of the punctures by sealing them. The characteristics of this layer are described subsequently.

### II. Layer of Self-Sealing Product

In the description of the layer of self-sealing product, unless expressly indicated otherwise, all the percentages (%) indicated are % by weight.

Moreover, any interval of values denoted by the expression “between a and b” represents the range of values greater than “a” and less than “b” (that is to say, limits a and b excluded), while any interval of values denoted by the expression “from a to b” means the range of values extending from “a” up to “b” (that is to say, including the strict limits a and b).

The abbreviation “phr” means parts by weight per hundred parts of elastomer in the solid state (of the total of the solid elastomers, if several solid elastomers are present).

The expression composition “based on” should be understood as meaning, generally, a composition comprising the mixture and/or the reaction product of its various components, it being possible for some of these components to be capable of reacting (indeed even intended to react) with one another, at least in part, during the various phases of manufacture of the composition, for example during its optional final crosslinking or vulcanization (curing).

### Layer of Self-Sealing Product Based on a Thermoplastic Stirene Elastomer

According to one embodiment, the layer 55 of self-sealing product comprises a thermoplastic stirene (“TPS”) elastomer and more than 200 phr of an extending oil for the elastomer. Thermoplastic stirene elastomers are thermoplastic elastomers provided in the form of stirene-based block copolymers.

Intermediate in structure between thermoplastic polymers and elastomers, they are composed, in a known way, of rigid polystirene sequences connected by flexible elastomer sequences, for example polybutadiene, polyisoprene or poly(ethylene/butylene). These are often triblock elastomers with two rigid segments connected by a flexible segment. The rigid and flexible segments can be positioned linearly, in star-branched fashion or in branched fashion.

The TPS elastomer is selected from the group consisting of stirene/butadiene/stirene (SBS), stirene/isoprene/stirene (SIS), stirene/isoprene/butadiene/stirene (SIBS), stirene/ethylene/butylene/stirene (SEBS), stirene/ethylene/propylene/stirene (SEPS) and stirene/ethylene/ethylene/propylene/stirene (SEEPS) block copolymers and the mixtures of these copolymers.

More preferably, the elastomer is selected from the group consisting of SEBS copolymers, SEPS copolymers and the mixtures of these copolymers.

The TPS elastomer can constitute all of the elastomer matrix or the majority by weight (preferably for more than 50%, more preferably for more than 70%) of the latter, when it comprises one or more other thermoplastic or nonthermoplastic elastomer(s), for example of the diene type.

Examples of such self-sealing layers and their properties are disclosed in the documents FR 2 910 382, FR 2 910 478 and FR 2 925 388.

Such a layer of self-sealing product can be preformed by extrusion of a flat profiled element at the appropriate dimensions for the application thereof on a manufacturing drum. An implementational example is presented in the document FR 2 925 388.

### Layer of Self-Sealing Product Based on Diene Elastomer

According to another implementational example, the layer 55 of self-sealing product is composed of an elastomer composition comprising at least, as predominant elastomer (preferably for more than 50 phr), an unsaturated diene elastomer, between 30 and 90 phr of a hydrocarbon resin and a liquid plasticizer with a glass transition temperature or Tg of less than −20° C., at a content of between 0 and 60 phr (phr meaning parts by weight per hundred parts of solid elastomer). It has the other essential characteristic of being devoid of filler or of comprising less than 120 phr thereof.

### Diene Elastomer

“Diene” elastomer or rubber, to remind the reader, should be understood, in a known way, as being an elastomer resulting at least in part (i.e., a homopolymer or a copolymer) from diene monomers (monomers carrying two conjugated or nonconjugated carbon-carbon double bonds).

These diene elastomers can be classified into two categories, saturated or unsaturated. In the present patent application, “unsaturated” (or “essentially unsaturated”) diene elastomer is understood to mean a diene elastomer resulting at least in part from conjugated diene monomers and having a content of units resulting from conjugated dienes which is greater than 30% (mol %); thus it is that diene elastomers, such as butyl rubbers or copolymers of dienes and of α-olefins of EPDM type, which can be described as “saturated” or “essentially saturated” diene elastomers due to their reduced content of units of diene origin (always less than 15 mol %), are excluded from this definition.

Use is preferably made of an unsaturated diene elastomer having a content (mol %) of units of diene origin (conjugated dienes) of greater than 50%, such a diene elastomer being more preferably selected from the group consisting of polybutadienes (BRs), natural rubber (NR), synthetic polyisoprenes (IRs), butadiene copolymers (for example, butadiene/stirene copolymers or SBRs), isoprene copolymers (of course, other than butyl rubber) and the mixtures of such elastomers.

In contrast to diene elastomers of the liquid type, the unsaturated diene elastomer of the composition is by definition solid. Preferably, its number-average molecular weight (Mn) is between 100 000 and 5 000 000 g/mol, more particularly between 200 000 and 4 000 000 g/mol. The Mn value is determined in a known way, for example by SEC: solvant tetrahydrofuran; temperature 35° C.; concentration 1 g/l; flow rate 1 ml/min; solution filtered through a filter with a porosity of 0.45 pm before injection; Moore calibration with standards (polyisoprene); set of 4 “Waters” columns in series (“Styragel” HMW7, HMW6E and 2 HT6E); detection by differential refractometer (“Waters 2410”) and its associated operating software (“Waters Empower”).

More preferably, the unsaturated diene elastomer of the composition of the layer of self-sealing product is an isoprene elastomer. The term “isoprene elastomer” is understood to mean, in a known way, an isoprene homopolymer or copolymer, in other words a diene elastomer selected from the group consisting of natural rubber (NR), synthetic polyisoprenes (IRs), butadiene/isoprene copolymers (BIRs), stirene/isoprene copolymers (SIRs), stirene/butadiene/isoprene copolymers (SBIRs) and the mixtures of these elastomers.

This isoprene elastomer is preferably natural rubber or a synthetic cis-1,4-polyisoprene; use is preferably made, among these synthetic polyisoprenes, of polyisoprenes having a content (mol %) of cis-1,4- bonds of greater than 90%, more preferably still of greater than 95%, in particular greater than 98%.

The unsaturated diene elastomer above, in particular isoprene elastomer, such as natural rubber, can constitute all of the elastomer matrix or the majority by weight (preferably for more than 50%, more preferably for more than 70%) of the latter when it comprises one or more other diene or nondiene elastomer(s), for example of the thermoplastic type. In other words and preferably, in the composition, the content of (solid) unsaturated diene elastomer, in particular of isoprene elastomer, such as natural rubber, is greater than 50 phr, more preferably greater than 70 phr. More preferably still, this content of unsaturated diene elastomer, in particular of isoprene elastomer, such as natural rubber, is greater than 80 phr.

According to a specific embodiment, the layer of self-sealing product comprises, preferably as predominant elastomer, a blend (or “mixture”) of at least two solid elastomers:
at least one (that is to say, one or more) polybutadiene or butadiene copolymer, referred to as “elastomer A”, and
at least one (that is to say, one or more) natural rubber or synthetic polyisoprene, referred to as “elastomer B”.

Mention may in particular be made, as polybutadienes, of those having a content of 1,2- units of between 4% and 80% or those having a content of cis-1,4- units of greater than 80%. Mention may in particular be made, as butadiene copolymers, of butadiene/stirene copolymers (SBRs), butadiene/isoprene copolymers (BIRs) or stirene/butadiene/isoprene copolymers (SBIRs). The SBR copolymers having a stirene content of between 5% and 50% by weight and more particularly between 20% and 40%, a content of 1,2- bonds on the butadiene part of between 4% and 65% and a content of trans-1,4- bonds of between 20% and 80%, the BIR copolymers having a isoprene content of between 5% and 90% by weight and a Tg of −40° C. to −80° C., and the SBIR copolymers having a stirene content of between 5% and 50% by weight and more particularly of between 10% and 40%, an isoprene content of between 15% and 60% by weight and more particularly between 20% and 50%, a butadiene content of between 5% and 50% by weight and more particularly of between 20% and 40%, a content of 1,2- units of the butadiene part of between 4% and 85%, a content of trans-1,4- units of the butadiene part of between 6% and 80%, a content of 1,2- plus 3,4- units of the isoprene part of between 5% and 70% and a content of trans-1,4- units of the isoprene part of between 10% and 50%, and more generally any SBIR copolymer having a Tg of between −20° C. and −70° C., are suitable in particular.

More preferably still, the elastomer A is a butadiene homopolymer, in other words a polybutadiene (BR), this polybutadiene preferably having a content (mol %) of cis-1,4- bonds of greater 90%, more preferably of greater than 95%.

The elastomer B is natural rubber or a synthetic polyisoprene; use is preferably made, among synthetic polyisoprenes, of cis-1,4-polyisoprenes, preferably those having a content (mol %) of cis-1,4- bonds of greater than 90%, more preferably still of greater than 95%, in particular of greater than 98%.

The above elastomers A and B can, for example, be block, random, sequential or microsequential elastomers and can be prepared in dispersion or in solution; they can be coupled and/or star-branched and/or branched or also functionalized, for example with a coupling and/or star-branching or functionalization agent. For coupling with carbon black, mention may be made, for example, of functional groups comprising a C—Sn bond or of aminated functional groups, such as benzophenone, for example; for coupling with a reinforcing inorganic filler, such as silica, mention may be made, for example, of silanol functional groups or polysiloxane functional groups having a silanol end (such as described, for example, in U.S. Pat. No. 6,013,718), of alkoxysilane groups (such as described, for example, in U.S. Pat. No. 5,977,238), of carboxyl groups (such as described, for example, in U.S. Pat. No. 6,815,473 or US 2006/0089445) or also of polyether groups (such as described, for example, in U.S. Pat. No. 6,503,973). Mention may also be made, as other examples of such functionalized elastomers, of elastomers (such as SBR, BR, NR or IR) of the epoxidized type.

According to a preferred embodiment, the elastomer A:elastomer B ratio by weight is preferably within a range from 20:80 to 80:20, more preferably still within a range from 30:70 to 70:30, in particular from 40:60 to 60:40.

It is in such respective concentration ranges of the two elastomers A and B that the best compromises in terms of self-sealing properties and operating temperature have been observed, according to the different specific uses targeted, in particular during use at low temperature (in particular at a temperature of less than 0° C.), in comparison with the use of natural rubber alone or of polybutadiene alone.

Elastomers A and B are by definition solid. In contrast to liquid, the term “solid” is understood to mean any substance not having the ability to eventually assume, at the latest after 24 hours, solely under the effect of gravity and at ambient temperature (23° C.), the shape of the container in which it is present.

In contrast to elastomers of the liquid type which can optionally be used as liquid plasticizers in the composition of the invention, the elastomers A and B and their blend are characterized by a very high viscosity: their Mooney viscosity in the raw state (i.e., noncrosslinked state) ML (1+4), measured at 100° C., is preferably greater than 20, more preferably greater than 30, in particular between 30 and 130.

As a reminder, the Mooney viscosity or plasticity characterizes, in a known way, solid substances. Use is made of an oscillating consistometer as described in Standard ASTM D1646 (1999). The Mooney plasticity measurement is carried out according to the following principle: the sample, analyzed in the raw state (i.e., before curing), is moulded (formed) in a cylindrical chamber heated to a given temperature (for example, 35° C. or 100° C.). After preheating for one minute, the rotor rotates within the test specimen at 2 revolutions/minute and the working torque for maintaining this movement is measured after rotating for 4 minutes. The Mooney viscosity (ML 1+4) is expressed in “Mooney unit” (MU, with 1 MU=0.83 newton·metre).

According to another possible definition, solid elastomer is also understood to mean an elastomer having a high molar mass, that is to say typically exhibiting a number-average molar mass (Mn) which is greater than 100 000 g/mol; preferably, in such a solid elastomer, at least 80%, more preferably at least 90%, of the area of the distribution of the molar masses (measured by SEC) is situated above 100 000 g/mol.

Preferably, the number-average molar mass (Mn) of each of the elastomers A and B is between 100 000 and 5 000 000 g/mol, more preferably between 150 000 and 4 000 000 g/mol; in particular, it is between 200 000 and 3 000 000 g/mol, more particularly between 200 000 and 1 500 000 g/mol. Preferably, their polydispersity index PI (Mw/Mn) is between 1.0 and 10.0, in particular between 1.0 and 3.0 as regards the elastomer A and between 3.0 and 8.0 as regards the elastomer B.

A person skilled in the art will know how to adjust, in the light of the present description and as a function of the specific application targeted for the composition of the invention, the average molar mass and/or the distribution of the molar masses of the elastomers A and B. According to a specific embodiment of the invention, he can, for example, opt for a broad distribution of molar masses. If he wishes to favour the fluidity of the self-sealing composition, he can instead favour the proportion of low molar masses. According to another specific embodiment, which may or may not be combined with the preceding embodiment, he can also favour the proportion of intermediate molar masses for the purpose of instead optimizing the self-sealing (filling) role of the composition. According to another specific embodiment, he can instead favour the proportion of high molar masses for the purpose of increasing the mechanical strength of the self-sealing composition.

These various molar mass distributions can be obtained, for example, by compounding different starting diene elastomers (elastomers A and/or elastomers B).

According to a preferred embodiment of the layer of self-sealing product, the above blend of solid elastomers A and B constitutes the only solid elastomer present in the self-sealing composition of the invention, that is to say that the overall content of the two elastomers A and B is then 100 phr; in other words, the contents of elastomer A and elastomer B are consequently each within a range from 10 to 90 phr, preferably from 20 to 80 phr, more preferably from 30 to 70 phr, in particular from 40 to 60 phr.

According to another specific embodiment of the layer of self-sealing product, when the blend of elastomers A and B does not constitute the only solid elastomer of the composition of the invention, the said blend preferably constitutes the predominant solid elastomer by weight in the composition of the invention; more preferably, the overall content of the two elastomers A and B is then greater than 50 phr, more preferably greater than 70 phr, in particular greater than 80 phr.

Thus, according to specific embodiments of the invention, the blend of elastomers A and B might be combined with other (solid) elastomers which are minor components by weight, whether unsaturated or saturated diene elastomers (for example butyl elastomers) or also elastomers other than diene elastomers, for example thermoplastic stirene (“TPS”) elastomers, for example selected from the group consisting of stirene/butadiene/stirene (SBS), stirene/isoprene/stirene (SIS), stirene/butadiene/isoprene/stirene (SBIS), stirene/isobutylene/stirene (SIBS), stirene/ethylene/butylene/stirene (SEBS), stirene/ethylene/propylene/stirene (SEPS) and stirene/ethylene/ethylene/propylene/stirene (SEEPS) block copolymers and the mixtures of these copolymers.

Surprisingly, the above blend of elastomers A and B, which is devoid of filler (or with a very low content of filler), has proved to be capable, after addition of a thermoplastic hydrocarbon resin within the recommended narrow range, of fulfilling the function of an effective self-sealing composition.

### Hydrocarbon Resin

The second essential constituent of the self-sealing composition according to this second embodiment is a hydrocarbon resin.

The designation “resin” is reserved in the present patent application, by definition known to a person skilled in the art, for a compound which is solid at ambient temperature (23° C.), in contrast to a liquid plasticizing compound, such as an oil.

Hydrocarbon resins are polymers well known to a person skilled in the art, essentially based on carbon and hydrogen, which can be used in particular as plasticizing agents or tackifying agents in polymer matrices. They are by nature miscible (i.e., compatible) at the contents used with the polymer compositions for which they are intended, so as to act as true diluents. They have been described, for example, in the work entitled “Hydrocarbon Resins” by R. Mildenberg, M. Zander and G. Collin (New York, VCH, 1997, ISBN 3-527-28617-9), Chapter 5 of which is devoted to their applications, in particular in the tire rubber field (5.5. “Rubber Tires and Mechanical Goods”). They can be aliphatic, cycloaliphatic, aromatic, hydrogenated aromatic, of the aliphatic/aromatic type, that is to say based on aliphatic and/or aromatic monomers. They can be natural or synthetic and may or may not be based on oil (if such is the case, they are also known under the name of petroleum resins). Their glass transition temperature (Tg) is preferably greater than 0° C., in particular greater than 20° C. (generally between 30° C. and 95° C.).

In a known way, these hydrocarbon resins can also be described as thermoplastic resins in the sense that they soften on heating and can thus be moulded. They can also be defined by a softening point or temperature, at which temperature the product, for example in the powder form, sticks together; this datum tends to replace the melting point, which is rather poorly defined, for resins in general. The softening temperature of a hydrocarbon resin is generally greater by approximately 50 to 60° C. than its Tg value.

In the composition of the layer of self-sealing product, the softening temperature of the resin is preferably greater than 40° C. (in particular between 40° C. and 140° C.), more preferably greater than 50° C. (in particular between 50° C. and 135° C.).

The said resin is used at a content by weight of between 30 and 90 phr. Below 30 phr, the puncture-resistant performance has proved to be inadequate due to an excessively high stiffness of the composition, whereas, above 90 phr, exposure to an inadequate mechanical strength of the material exists with in addition a risk of a damaged performance at high temperature (typically greater than 60° C.). For these reasons, the content of resin is preferably between 40 and 80 phr, more preferably still at least equal to 45 phr, in particular within a range from 45 to 75 phr.

According to a preferred embodiment of the layer of self-sealing product, the hydrocarbon resin exhibits at least (any) one, more preferably all, of the following characteristics:
a Tg of greater than 25° C.;
a softening point of greater than 50° C. (in particular of between 50° C. and 135° C.);
a number-average molecular weight (Mn) of between 400 and 2000 g/mol;
a polydispersity index (PI) of less than 3 (as a reminder: PI=Mw/Mn with Mw the weight-average molecular weight).

More preferably, this hydrocarbon resin exhibits at least (any) one, more preferably all, of the following characteristics:
a Tg of between 25° C. and 100° C. (in particular between 30° C. and 90° C.);
a softening point of greater than 60° C., in particular of between 60° C. and 135° C.;
a number-average molecular weight Mn of between 500 and 1500 g/mol;
a polydispersity index PI of less than 2.

The Tg is measured according Standard ASTM D3418 (1999). The softening point is measured according to Standard ISO 4625 (Ring and Ball method). The macrostructure (Mw, Mn and PI) is determined by steric exclusion chromatography (SEC): solvant tetrahydrofuran; temperature 35° C.; concentration 1 g/l; flow rate 1 ml/min; solution filtered through a filter with a porosity of 0.45 μm before injection; Moore calibration with polystirene standards; set of 3 “Waters” columns in series (“Styragel” HR4E, HR1 and HR0.5); detection by differential refractometer (“Waters” 2410) and its associated operating software (“Waters Empower”).

Mention may be made, as examples of such hydrocarbon resins, of those selected from the group consisting of cyclopentadiene (abbreviated to CPD) or dicyclopentadiene (abbreviated to DCPD) homopolymer or copolymer resins, terpene homopolymer or copolymer resins, C₅ fraction homopolymer or copolymer resins, and the mixtures of these resins. Mention may more particularly be made, among the above copolymer resins, of those selected from the group consisting of (D)CPD/vinylaromatic copolymer resins, (D)CPD/terpene copolymer resins, (D)CPD/C₅ fraction copolymer resins, terpene/vinylaromatic copolymer resins, C₅ fraction/vinylaromatic copolymer resins, and the mixtures of these resins.

The term “terpene” combines here, in a known way, α-pinene, β-pinene and limonene monomers; use is preferably made of a limonene monomer, a compound which exists, in a known way, in the form of three possible isomers: L-limonene (laevorotatory enantiomer), D-limonene (dextrorotatory enantiomer) or else dipentene, the racemate of the dextrorotatory and laevorotatory enantiomers. Suitable as vinylaromatic monomer are, for example, stirene, α-methylstirene, ortho-methylstirene, meta-methylstirene, para-methylstirene, vinyltoluene, para-(tert-butyl)stirene, methoxystirenes, chlorostirenes, hydroxystirenes, vinylmesitylene, divinylbenzene, vinylnaphthalene or any vinylaromatic monomer resulting from a C₉ fraction (or more generally from a C₈ to C₁₀ fraction).

More particularly, mention may be made of the resins selected from the group consisting of (D)CPD homopolymer resins, (D)CPD/stirene copolymer resins, polylimonene resins, limonene/stirene copolymer resins, limonene/D(CPD) copolymer resins, C₅ fraction/stirene copolymer resins, C₅ fraction/C₉ fraction copolymer resins, and the mixtures of these resins.

All the above resins are well known to a person skilled in the art and are commercially available, for example sold by DRT under the name “Dercolyte” as regards the polylimonene resins, by Neville Chemical Company under the name “Super Nevtac” or by Kolon under the name “Hikorez” as regards the C₅ fraction/stirene resins or C₅ fraction/C₉ fraction resins, or by Struktol under the name “40 MS” or “40 NS” or by Exxon Mobil under the name “Escorez” (mixtures of aromatic and/or aliphatic resins).

### Filler

The composition of the layer of self-sealing product according to this second embodiment has the other essential characteristic of comprising from 0 to less than 120 phr of at least one (that is to say one or more) filler, including from 0 to less than 30 phr of at least one (that is to say, one or more) reinforcing filler.

Filler is understood here to mean any type of filler, whether reinforcing (typically having nanometric particles, preferably with a weight-average size of less than 500 nm, in particular between 20 and 200 nm) or nonreinforcing or inert (typically having micrometric particles, preferably with a weight-average size of greater than 1 μm, for example between 2 and 200 μm), the weight-average size being measured in a way well known to a person skilled in the art (by way of example, according to Application WO2009/083160, section 1.1).

Mention will in particular be made, as examples of fillers known as reinforcing to a person skilled in the art, of carbon black or of a reinforcing inorganic filler, such as silica in the presence of a coupling agent, or a blend of these two types of filler. This is because, in a known way, silica is a reinforcing filler in the presence of a coupling agent which allows it to bond to the elastomer.

All carbon blacks are suitable as carbon blacks, for example, in particular the blacks conventionally used in tires. Mention will be made, for example, among the latter, of carbon blacks of 300, 600, 700 or 900 grade (ASTM) (for example, N326, N330, N347, N375, N683, N772 or N990). Suitable in particular as reinforcing inorganic fillers are highly dispersible mineral fillers of the silica (SiO₂) type, in particular precipitated or fumed silicas exhibiting a BET specific surface of less than 450 m²/g, preferably from 30 to 400 m²/g.

Mention will in particular be made, as examples of fillers other than reinforcing fillers, or inert fillers, known to a person skilled in the art, of those selected from the group consisting of ashes (i.e., combustion residues), microparticles of natural calcium carbonates (chalk) or synthetic calcium carbonates, synthetic or natural silicates (such as kaolin, talc, mica, cloisite), silicas (in the absence of coupling agent), titanium oxides, aluminas, aluminosilicates (clay, bentonite), and their mixtures. Colouring fillers or fillers coloured, for example, by pigments can advantageously be used to colour the composition according to the colour desired. Preferably, the composition of the invention comprises a filler other than a reinforcing filler selected from the group consisting of chalk, talc, kaolin and their mixtures.

The physical state under which the filler is provided is not important, whether in the form of a power, microspheres, granules, beads or any other appropriate densified form. Of course, filler is also understood to mean mixtures of different reinforcing and/or nonreinforcing fillers.

These reinforcing or other fillers are usually present to give dimensional stability, that is to say a minimum mechanical strength, to the final composition. Less thereof is preferably placed in the composition in proportion as the filler is known to be reinforcing with respect to an elastomer, in particular a diene elastomer, such as natural rubber or polybutadiene.

A person skilled in the art will be able, in the light of the present description, to adjust the content of filler of the composition of the invention in order to achieve the property levels desired and to adjust the formulation to the specific application envisaged. Preferably, the composition of the invention comprises from 0 to less than 100 phr of filler, preferably from 0 to less than 70 phr of filler, including from 0 to less than 15 phr of reinforcing filler, preferably from 0 to less than 10 phr of reinforcing filler.

More preferably still, the composition of the invention comprises from 0 to 70 phr of filler, including from 0 to less than 5 phr of reinforcing filler. Very preferably, the composition of the invention comprises a filler other than a reinforcing filler at a content which can range from 5 to 70 phr, preferably from 10 to 30 phr.

According to the application envisaged, the invention can in particular come in two embodiments, according to the content of filler. This is because an excessively high amount of filler is damaging to the required properties of flexibility, deformability and ability to creep, while the presence of a certain amount of filler (for example from 30 to less than 120 phr) makes it possible to improve the processability and to reduce the cost.

Thus, according to a first specific embodiment, the composition has a very low content of filler, that is to say that it comprises from 0 to less than 30 phr of filler in total (including from 0 to less than 30 phr of reinforcing filler), preferably from 0 to less than 30 phr of filler, including from 0 to less than 15 phr of reinforcing filler (more preferably from 0 to less than 10 phr of reinforcing filler). According to this first embodiment, this composition has the advantage of making possible a self-sealing composition having good puncture-resistant properties under cold conditions and under hot conditions.

More preferably, according to this first specific embodiment, if a reinforcing filler is present in the composition of the invention, its content is preferably less than 5 phr (i.e., between 0 and 5 phr), in particular less than 2 phr (i.e., between 0 and 2 phr). Such contents have proved to be particularly favourable to the process for the manufacture of the composition of the invention, while giving the latter an excellent self-sealing performance. Use is more preferably made of a content of between 0.5 and 2 phr, in particular when carbon black is concerned.

Preferably again, according to this first specific embodiment, if a filler other than a reinforcing filler is used, its content is preferably from 5 to less than 30 phr, in particular from 10 to less than 30 phr.

Furthermore, according to a second specific embodiment, which is preferred, the composition comprises from 30 to less than 120 phr of filler, preferably from more than 30 to less than 100 phr and more preferably from 35 to 80 phr, including, according to this second embodiment, from 0 to less than 30 phr of reinforcing filler (more preferably from 0 to less than 15 phr). According to this second specific embodiment, this composition has the advantage of improving the processability and of reducing the cost while not being excessively damaged with regard to its properties of flexibility, deformability and ability to creep. Furthermore, this second embodiment confers, on the composition, a markedly improved puncture-resistant performance.

Preferably, according to this second specific embodiment, if a reinforcing filler is present in the composition of the invention, its content is preferably less than 5 phr (i.e., between 0 and 5 phr), in particular less than 2 phr (i.e., between 0 and 2 phr). Such contents have proved to be particularly favourable to the process for the manufacture of the composition of the invention, while giving the latter an excellent self-sealing performance. Use is more preferably made of a content of between 0.5 and 2 phr, in particular when carbon black is concerned.

Preferably, according to this second specific embodiment, the content of filler other than reinforcing filler is from 5 to less than 120 phr, in particular from 10 to less than 100 phr and more preferably from 15 to 80 phr. Very preferably, the content of filler other than a reinforcing filler is within a range extending from 25 to 50 phr, more preferably still from 30 to 50 phr.

### Liquid Plasticizer

The composition of the layer of self-sealing product according to the second embodiment can additionally comprise, at a content of less than 60 phr (in other words, between 0 and 60 phr), a liquid plasticizing agent (liquid at 23° C.), referred to as “low Tg” plasticizing agent, the role of which is in particular to soften the matrix by diluting the diene elastomer and the hydrocarbon resin, improving in particular the “cold” self-sealing performance (that is to say, typically for a temperature of less than 0° C.); its Tg is by definition less than −20° C. and is preferably less than −40° C.

Any liquid elastomer or any extending oil, whether of aromatic or nonaromatic nature, more generally any liquid plasticizing agent known for its plasticizing properties with respect to elastomers, in particular diene elastomers, can be used. At ambient temperature (23° C.), these plasticizers or these oils, which are more or less viscous, are liquids (that is to say, as a reminder, substances having the ability to eventually assume the shape of their container), in contrast in particular to hydrocarbon resins which are by nature solid at ambient temperature.

Suitable in particular are liquid elastomers having a low number-average molecular weight (Mn), typically of between 300 and 90 000, more generally between 400 and 50 000, for example in the form of liquid BR, liquid SBR, liquid IR or liquid depolymerized natural rubber, such as described, for example, in the abovementioned patent documents U.S. Pat. No. 4,913,209, U.S. Pat. No. 5,085,942 and U.S. Pat. No. 5,295,525. Use may also be made of mixtures of such liquid elastomers with oils, such as described below.

Extending oils, in particular those selected from the group consisting of polyolefin oils (that is to say, resulting from the polymerization of olefins, monoolefins or diolefins), paraffinic oils, naphthenic oils (of low or high viscosity and hydrogenated or nonhydrogenated), aromatic or DAE (Distillate Aromatic Extracts) oils, MES (Medium Extracted Solvates) oils, TDAE (Treated Distillate Aromatic Extracts) oils, mineral oils, vegetable oils (and their oligomers, e.g. rapeseed, soybean or sunflower oils) and the mixtures of these oils, are also suitable.

According to a specific embodiment, use is made, for example, of an oil of the polybutene type, in particular a polyisobutylene (abbreviated to “PIB”) oil, which has demonstrated an excellent compromise in properties in comparison with the other oils tested, in particular with a conventional oil of the paraffinic type. By way of examples, PIB oils are sold in particular by Univar under the “Dynapak Poly” name (e.g. “Dynapak Poly 190”) and by BASF under the “Glissopal” (e.g. “Glissopal 1000”) or “Oppanol” (e.g. “Oppanol B12”) names; paraffinic oils are sold, for example, by Exxon under the name “Telura 618” or by Repsol under the name “Extensol 51”.

Also suitable as liquid plasticizers are ether, ester, phosphate or sulphonate plasticizers, more particularly those selected from esters and phosphates. Mention may be made, as preferred phosphate plasticizers, of those which comprise between 12 and 30 carbon atoms, for example trioctyl phosphate. Mention may in particular be made, as preferred ester plasticizers, of the compounds selected from the group consisting of trimellitates, pyromellitates, phthalates, 1,2-cyclohexanedicarboxylates, adipates, azelates, sebacates, glycerol triesters and the mixtures of these compounds. Mention may be made, among the above triesters, as preferred glycerol triesters, of those which are composed predominantly (for more than 50% by weight, more preferably for more than 80% by weight) of an unsaturated C₁₈ fatty acid, that is to say a fatty acid selected from the group consisting of oleic acid, linoleic acid, linolenic acid and the mixtures of these acids. More preferably, whether of synthetic or natural origin (the case, for example, of sunflower or rapeseed vegetable oils), the fatty acid used is composed, for more than 50% by weight, more preferably still for more than 80% by weight, of oleic acid. Such triesters (trioleates) having a high content of oleic acid are well known—they have been described, for example, in Application WO 02/088238 (or US 2004/0127617)—as plasticizing agents in tire treads.

The number-average molecular weight (Mn) of the liquid plasticizer is preferably between 400 and 25 000 g/mol, more preferably still between 800 and 10 000 g/mol. For excessively low Mn weights, there exists a risk of migration of the plasticizer to the outside of the composition, whereas excessively high weights can result in excessive stiffening of this composition. An Mn weight of between 1 000 and 4 000 g/mol has proved to constitute an excellent compromise for the targeted applications, in particular for use in a tire.

The number-average molecular weight (Mn) of the plasticizer can be determined in a known way, in particular by SEC, the sample being dissolved beforehand in tetrahydrofuran at a concentration of approximately 1 g/l; the solution is then filtered through a filter with a porosity of 0.45 μm before injection. The apparatus is the “Waters Alliance” chromatographic line. The elution solvent is tetrahydrofuran, the flow rate is 1 ml/min, the temperature of the system is 35° C. and the analysis time is 30 min. A set of two “Waters” columns having the name “Styragel HT6E” is used. The injected volume of the solution of the polymer sample is 100 μl. The detector is a “Waters 2410” differential refractometer and its associated software for making use of the chromatographic data is the “Waters Millenium” system. The calculated average molecular weights are relative to a calibration curve produced with polystirene standards.

To sum up, the liquid plasticizer is preferably selected from the group consisting of liquid elastomers, polyolefin oils, naphthenic oils, paraffinic oils, DAE oils, MES oils, TDAE oils, mineral oils, vegetable oils, ether plasticizers, ester plasticizers, phosphate plasticizers, sulphonate plasticizers and the mixtures of these compounds. More preferably, this liquid plasticizer is selected from the group consisting of liquid elastomers, polyolefin oils, vegetable oils and the mixtures of these compounds.

A person skilled in the art will be able, in the light of the description and implementational examples which follow, to adjust the amount of liquid plasticizer as a function of the specific conditions of use of the self-sealing composition, in particular of the tire in which it is intended to be used.

Preferably, the content of liquid plasticizer is within a range from 5 to 40 phr, more preferably within a range from 10 to 30 phr. Below the minima indicated, there is a risk of the elastomer composition exhibiting a stiffness which is too high for some applications, whereas, above the recommended maxima, a risk arises of insufficient cohesion of the composition and of a deterioration in the self-sealing properties.

### Various Additives

The base constituents of the layer of self-sealing product described above, namely unsaturated diene elastomer, plasticizing hydrocarbon resin, optional liquid plasticizer and optional filler, are sufficient by themselves alone for the self-sealing composition to fully perform its puncture-resistant role with regard to the tires in which it is used.

However, various other additives can be added, typically in a small amount (preferably at contents of less than 20 phr, more preferably of less than 15 phr), such as, for example, protection agents, such as UV stabilizers, antioxidants or antiozonants, various other stabilizers, or colouring agents which can advantageously be used for the colouring of the self-sealing composition. According to the application targeted, fibres, in the form of short fibres or of a slurry, might optionally be added to give greater cohesion to the self-sealing composition.

According to a preferred embodiment of the second embodiment of the composition of the layer of self-sealing product, the self-sealing composition additionally comprises a system for crosslinking the unsaturated diene elastomer which can be composed of just one or several compounds. This crosslinking agent is preferably a crosslinking agent based on sulphur and/or on a sulphur donor. In other words, this crosslinking agent is a “vulcanization” agent.

According to a preferred embodiment, the vulcanization agent comprises sulphur and, as vulcanization activator, a guanidine derivative, that is to say a substituted guanidine. Substituted guanidines are well known to a person skilled in the art (see, for example, WO 00/05300): mention will be made, as nonlimiting examples, of N,N′-diphenylguanidine (abbreviated to “DPG”), triphenylguanidine or also di(o-tolyl)guanidine. Use is preferably made of DPG. The sulphur content is, for example, between 0.1 and 1.5 phr, especially between 0.2 and 1.2 phr (in particular between 0.2 and 1.0 phr), and the content of guanidine derivative is itself between 0 and 1.5 phr, in particular between 0 and 1.0 phr (in particular within a range from 0.2 to 0.5 phr).

The said crosslinking or vulcanization agent does not require the presence of a vulcanization accelerator. According to a preferred embodiment, the composition can thus be devoid of such an accelerator or at the very most can comprise less than 1 phr thereof, more preferably less than 0.5 phr thereof.

However, in general, if such an accelerator is used, mention may be made, as an example, of any compound (“primary” or “secondary” accelerator) capable of acting as vulcanization accelerator for diene elastomers in the presence of sulphur, in particular accelerators of the thiazole type and their derivatives, accelerators of sulphenamide, thiuram, dithiocarbamate, dithiophosphate, thiourea and xanthate types.

Mention may in particular be made, as examples of such accelerators, of the following compounds: 2-mercaptobenzothiazyl disulphide (abbreviated to “MBTS”), N-cyclohexyl-2-benzothiazolesulphenamide (“CBS”), N,N-dicyclohexyl-2-benzothiazolesulphenamide (“DCBS”), N-(tert-butyl)-2-benzothiazolesulphenamide (“TBBS”), N-(tert-butyl)-2-benzothiazolesulphenimide (“TBSI”), zinc dibenzyldithiocarbamate (“ZBEC”), 1-phenyl-2,4-dithiobiuret (“DTB”), zinc dibutyl phosphorodithioate (“ZBPD”), zinc 2-ethylhexyl phosphorodithioate (“ZDT/S”), bis[O,O-di(2-ethylhexyl) thiophosphonyl] disulphide (“DAPD”), dibutylthiourea (“DBTU”), zinc isopropyl xanthate (“ZIX”) and the mixtures of these compounds. According to another advantageous embodiment, the above vulcanization system can be devoid of zinc or of zinc oxide (known as vulcanization activators) or at the very most can comprise less than 1 phr thereof, more preferably less than 0.5 phr thereof.

According to another preferred specific embodiment of the invention, the vulcanization agent comprises a sulphur donor. The amount of such a sulphur donor will be adjusted preferably to between 0.5 and 15 phr, more preferably between 0.5 and 10 phr (in particular between 1 and 5 phr), in particular so as to achieve the preferred equivalent sulphur contents indicated above.

Sulphur donors are well known to a person skilled in the art; mention will in particular be made of thiuram polysulphides, which are known vulcanization accelerators and which have the formula (I):

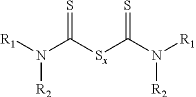

in which:
x is a number (integer, or decimal number in the case of mixtures of polysulphides) which is equal to or greater than two, preferably within a range from 2 to 8;
R₁ and R₂, which are identical or different, represent a hydrocarbon radical preferably chosen from alkyls having from 1 to 6 carbon atoms, cycloalkyls having from 5 to 7 carbon atoms, or aryls, aralkyls or alkaryls having from 6 to 10 carbon atoms.

In the above formula (I), R₁ and R₂ might form a divalent hydrocarbon radical comprising from 4 to 7 carbon atoms.

These thiuram polysulphides are more preferably selected from the group consisting of tetrabenzylthiuram disulphide (“TBzTD”), tetramethylthiuram disulphide (“TMTD”), dipentamethylenethiuram tetrasulphide (“DPTT”), and the mixtures of such compounds. Use is more preferably made of TBzTD, particularly at the preferred contents indicated above for a sulphur donor (i.e., between 0.1 and 15 phr, more preferably between 0.5 and 10 phr, in particular between 1 and 5 phr).

In addition to the solid elastomers and other additives described above, the composition of the invention might also comprise, preferably according to a minor fraction by weight with respect to the blend of solid elastomers A and B, solid polymers other than elastomers, such as, for example, thermoplastic polymers.

In addition to the elastomers described above, the self-sealing composition might also comprise, still according to a minor fraction by weight with respect to the unsaturated diene elastomer, polymers other than elastomers, such as, for example, thermoplastic polymers compatible with the unsaturated diene elastomer.

### Manufacture of the Layer of Self-Sealing Product

The composition of the layer of self-sealing product according to the second embodiment described above can be manufactured by any appropriate means, for example by compounding and/or kneading in blade mixers or open mills, until an intimate and homogeneous mixture of its various components has been obtained.

However, the following manufacturing problem may be presented: in the absence of filler, or at the very least of a significant amount of filler, the composition exhibits weak cohesion. This lack of cohesion may be such that the adhesiveness of the composition, furthermore due to the presence of a relatively high content of hydrocarbon resin, is not compensated for and prevails; this then results in a risk of undesirable adhesive bonding to the compounding equipment, which may be unacceptable under industrial processing conditions.

In order to overcome the above problems, the self-sealing composition, when it comprises a vulcanization system, can be prepared according to a process comprising the following stages:
a) in a first step, a masterbatch comprising at least the unsaturated diene elastomer or, as the case may be, the blend of the solid elastomers A and B and between 30 and 90 phr of the hydrocarbon resin is manufactured by mixing these various components in a mixer, at a temperature or up to a temperature referred to as “hot compounding temperature” (or “first temperature”) which is greater than the softening point of the hydrocarbon resin;
b) then at least a crosslinking system is incorporated in the said masterbatch, everything being mixed, in the same mixer or in a different mixer, at a temperature or up to a temperature referred to as “second temperature”, which is maintained below 100° C., in order to obtain the said self-sealing composition.

The first and second temperatures above are, of course, those of the masterbatch and of the self-sealing composition, respectively, measurable in situ and not the set temperatures of the mixers themselves.

The term “masterbatch” should be understood here, by definition, as meaning the mixture of at least the diene elastomer and of the hydrocarbon resin, the precursor mixture of the final ready-for-use self-sealing composition.

The liquid plasticizer can be incorporated at any time, in all or part, in particular during the manufacture of the masterbatch itself (in this case, before, during or after the incorporation of the hydrocarbon resin in the diene elastomer), “under hot conditions” (that is to say, at a temperature greater than the softening point of the resin) and at a lower temperature, or, for example, after the manufacture of the masterbatch (in this case, before, during or after the addition of the crosslinking system).

Various additives can optionally be incorporated in this masterbatch, whether they are intended for the masterbatch proper (for example, a stabilizing agent, a colouring agent, a UV stabilizer, an antioxidant, and the like) or for the final self-sealing composition for which the masterbatch is intended.

Such a process has proved to be particularly well suited to the rapid manufacture, under processing conditions acceptable from the industrial viewpoint, of an effective self-sealing composition, it being possible for this composition to comprise high contents of hydrocarbon resin without requiring in particular the use of a liquid plasticizer at a particularly high content.

It is during the hot compounding stage a) that the diene elastomer is brought into contact with the hydrocarbon resin for the manufacture of the masterbatch. In the initial state, that is to say before contact thereof with the elastomer, the resin can be provided in the solid state or in the liquid state. Preferably, for better compounding, the solid diene elastomer is brought into contact with the hydrocarbon resin in the liquid state. It is sufficient, for this, to heat the resin to a temperature greater than its softening point. According to the type of hydrocarbon resin used, the hot compounding temperature is typically greater than 70° C., generally greater than 90° C., for example between 100° C. and 150° C.

It is preferable to introduce, at least in part, the liquid plasticizer during the stage a) of manufacture of the masterbatch itself, or preferably, in this case, either at the same time as the hydrocarbon resin or after the introduction of the latter. According to a particularly advantageous embodiment, a mixture of the hydrocarbon resin and of the liquid plasticizer can be prepared prior to the incorporation in the diene elastomer.

The stage b) of incorporation of the crosslinking system is carried out at a temperature preferably of less than 80° C., furthermore preferably less than the softening point of the resin. Thus, according to the type of hydrocarbon resin used, the compounding temperature of the stage b) is preferably less than 50° C., more preferably between 20° C. and 40° C.

If necessary, an intermediate stage of cooling the masterbatch can be inserted between stages a) and b) above, in order to bring its temperature to a value of less than 100° C., preferably less than 80° C., in particular below the softening point of the resin, this before introduction (stage b)) of the crosslinking system into the masterbatch prepared previously.

When a filler, such as carbon black, is used, it can be introduced during stage a), that is to say at the same time as the unsaturated diene elastomer and the hydrocarbon resin, or else during stage b), that is to say at the same time as the crosslinking system. It has been found that a very low proportion of carbon black, preferably of between 0.5 and 2 phr, further improves the compounding and the manufacture of the composition, and its final extrudability.

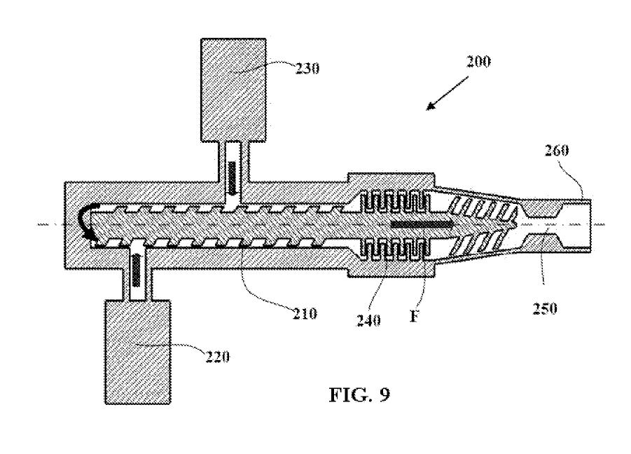

The stage a) of manufacture of the masterbatch is preferably carried out in a compounding screw extruder, as represented diagrammatically, for example, in a simple way, in FIG. 9.

This FIG. 9 shows a compounding screw extruder 200 essentially comprising an extrusion screw (for example a single screw) 210, a first metering pump 220 for the diene elastomer (solid) and at least one second metering pump 230 for the resin (solid or liquid) and the liquid plasticizer. The hydrocarbon resin and the liquid plasticizer can be introduced, for example, by means of a single metering pump, if they have already been mixed beforehand, or else can be introduced separately by means of a second pump and a third pump (third pump not represented in FIG. 9, for simplicity), respectively. The metering pumps 220, 230 make it possible to increase in pressure while retaining control of the metering and the initial characteristics of the materials, the separation of the metering (elastomer, resin and liquid plasticizer) and compounding functions in addition offering better control of the process.

The products, pushed by the extrusion screw, are intimately mixed under the very strong shearing contributed by the rotation of the screw, thus progressing through the mixer, for example up to a “chopper-homogenizer” part 240, at the outlet of which zone the final masterbatch 250 thus obtained, progressing in the direction of the arrow F, is finally extruded through a die 260 which makes it possible to extrude the product at the desired dimensions.

The masterbatch thus extruded, which is ready to be used, is subsequently transferred and cooled, for example on an external mixer of the two-roll open mill type, for introduction of the crosslinking system and the optional filler, the temperature inside the said external mixer being kept lower than 100° C., preferably lower than 80° C., and, furthermore, being preferably lower than the softening point of the resin. Advantageously, the above rolls are cooled, for example by circulation of water, to a temperature of less than 40° C., preferably of less than 30° C., so as to prevent any undesirable adhesive bonding of the composition to the walls of the mixer.

It is possible to directly form the masterbatch at the outlet of the extrusion device 200 in order to make it easier to transport it and/or to place it on the external mixer. It is also possible to use continuous feeding of the external mixer of the two-roll open mill type.

By virtue of the preferred specific device and preferred process which are described above, it is possible to prepare the composition of the layer of self-sealing product under satisfactory industrial conditions, without the risk of contaminating the equipment due to undesirable adhesive bonding of the composition to the walls of the mixers.

### III. Manufacture of the Tires

The tires of FIGS. 5 and 7 can be manufactured, as indicated in the document WO 2011/032886, by incorporating a layer of self-sealing product in a nonvulcanized tire blank using a manufacturing drum and the other techniques normal in the manufacture of tires.

More specifically, a protective layer, for example a chlorinated thermoplastic film, is applied first to the manufacturing drum. This protective layer can be wound all around the manufacturing drum and then welded. It is also possible to install a pre-welded protective sleeve. All the other normal components of the tire are subsequently applied, successively.

The layer of self-sealing product is positioned directly on the protective layer. This layer was preformed beforehand by any known technique, for example extrusion or calendering. Its thickness is preferably greater than 0.3 mm, more preferably between 0.5 and 10 mm (in particular, for tires of passenger vehicles, between 1 and 5 mm). An airtight layer is then placed on the layer of self-sealing product, followed by the carcass ply.

In a two-step manufacturing process, the tire blank is then shaped to take the form of a torus. The protective layer, composed of a composition based on a chlorinated thermoplastic polymer film, has a sufficiently low stiffness and sufficient uniaxial and biaxial extensibility and is sufficiently bonded to the surface of the layer of self-sealing product, due to the tack of the latter, to follow the movements of the tire blank without detaching or tearing.

After the shaping, the crown plies and the tread are positioned on the blank of the tire. The blank, thus completed, is placed in a curing mould and is vulcanized. During the vulcanization, the protective layer protects the curing membrane of the mould from any contact with the layer of self-sealing product.

On departing from the curing mould, the protective layer remains attached to the layer of self-sealing product. This protective layer does not comprise any crack or tear and detaches without any difficulty from the curing membrane.

The tires of FIGS. 5 and 7 can also be manufactured using a rigid core which imposes the shape of the internal cavity of the tire. In this process, first the protective layer is applied to the surface of the core, followed by all the other constituents of the tire. The application to the core is carried out in the order required by the final architecture. The constituents of the tire are positioned directly in their final place, without being subjected to shaping at any point in the preparation. This preparation can in particular use the devices described in Patent EP 0 243 851 for the positioning of the threads of the carcass reinforcement, EP 0 248 301 for the positioning of the crown reinforcements and EP 0 264 600 for the positioning of the rubber liners. The tire can be moulded and vulcanized as set out in U.S. Pat. No. 4,895,692. The presence of the protective layer makes it possible, as in the case of the curing membrane, to easily separate the tire from the core on conclusion of the vulcanization phase.

It is also possible to install the layer of self-sealing product after the vulcanization of the tire by any appropriate means, for example by adhesive bonding, by spraying or also by direct extrusion over the internal surface of the tire.

The layers of self-sealing product presented in FIGS. 5 and 7 correspond to the second embodiment described above. These layers are composed of a self-sealing composition comprising the three essential constituents, which are natural rubber (100 phr), approximately 50 phr of hydrocarbon resin (“Escorez 2101” from Exxon Mobil—softening point equal to approximately 90° C.) and approximately 15 phr of liquid polybutadiene (“Ricon 154” from Sartomer Cray Valley—Mn equal to approximately 5200); it additionally comprises a very small amount (1 phr) of carbon black (N772).

The above self-sealing composition was prepared using a single-screw extruder (L/D=40) as represented diagrammatically in FIG. 9 (already commented upon above); the three basic constituents (NR, resin and liquid plasticizer) were mixed at a temperature (of between 100 and 130° C.) greater than the softening point of the resin. The extruder used comprises two different feeds (hoppers) (NR, on the one hand, resin and liquid plasticizer, on the other hand, mixed beforehand at a temperature of 130 to 140° C. approximately) and a pressurized liquid injection pump for the resin/liquid plasticizer mixture (injected at a temperature of 100 to 110° C. approximately); when the elastomer, the resin and the liquid plasticizer are thus intimately mixed, it has been found that the undesirable tackiness of the composition very significantly decreased.

Similar results have been obtained using, as layer of self-sealing product, a composition comprising a thermoplastic stirene TPS elastomer, as described above.

The above extruder was provided with a die which makes it possible to extrude the masterbatch at the desired dimensions towards an external mixer of the two-roll open mill type, for final incorporation of the other constituents, namely the sulphur-based vulcanization system (for example 0.5 or 1.2 phr) and DPG (for example 0.3 phr) and carbon black (at a content of 1 phr), at a low temperature maintained at a value of less than +30° C. (cooling of the rolls by circulation of water).

### IV. Results Obtained

### IV-1. Resistance to Perforation

Tests have been carried out on tires corresponding to FIG. 5 (tire B) and FIG. 4 (tire T) with and without layer of self-sealing product 55, fitted to rims and a vehicle which are similar to the preceding tests. The layer of self-sealing product has a thickness of 3 mm.

Eight perforations with a diameter of 5 mm were produced, on one of the fitted and inflated tires, through the tread and the crown block using punches, which were immediately withdrawn.

This tire withstood running on a rolling drum at 150 km/h, under a nominal load of 400 kg, without loss of pressure for more than 1500 km, beyond which distance running was stopped.

The same procedure was carried out on another tire, this time leaving the perforating objects in place for a weak. The same excellent result was obtained.

Without self-sealing composition and under the same conditions as above, the tire thus perforated loses its pressure in less than one minute, becoming completely incapable of running.

Endurance tests were carried out on tires in accordance with the invention, identical to the above but having run for 750 km, up to a speed of 150 km/h, this time leaving the punches in place in their perforations. After extraction of the punches (or expulsion of the latter following the running), these tires of the invention withstood running on a rolling drum without loss of pressure, under the same conditions as above (distance travelled of 1500 km at a speed of 150 km/h and under a nominal load of 400 kg).

### IV-2. Pinch Shock Resistance

FIG. 6 shows results of calculations relating to a tire sidewall subjected to large deformations. The distributed tension T (in daN/cm) was plotted as a function of the load Z (in daN). Curves 11 and 12 correspond to the reference tire of FIG. 4 (shoulder lock configuration). The carcass reinforcement comprises 220×2 reinforcers (each reinforcing element consists of two threads each having a linear density of 200 tex) made of PET. The breaking strength of each reinforcing element is 268 daN/cm, which means that the total breaking strength is equal to 528 daN/cm. The curve 11 represents the tension absorbed by the reinforcing elements of the outward strand 62 of the carcass reinforcement and the curve 21 represents the tension absorbed by the reinforcing elements of the return strand 63. It is found that, when the load is high, it is the reinforcing elements of the return strand which absorb more tension. The curves 21 and 22 correspond to the tire of FIG. 5. The carcass reinforcement comprises 144×2 reinforcers made of PET. The breaking strength of each reinforcing element is 187 daN/cm. The additional strengthening reinforcement comprises 334×2 reinforcers made of PET. The breaking strength of each reinforcing element is 328 daN/cm. The total breaking strength is thus equal to 515 daN/cm. The curve 21 represents the tension absorbed by the reinforcing elements of the carcass reinforcement 60 and the curve 21 represents the tension absorbed by the reinforcing elements of the additional strengthening reinforcement 120. Although the total breaking strength is lower, the tire according to the invention bursts at significantly higher loads than the reference tire, which clearly illustrates the advantage of combining an “underdesigned” carcass reinforcement with an additional strengthening reinforcement having a greater breaking strength.

These calculation results have subsequently been confirmed by tests on tires.

1. A tire in the form of a torus having an internal wall and an external wall, the internal wall being, at least in part, covered with an airtight layer, the tire having an axis of rotation and comprising:
two beads intended to come into contact with a mounting rim, each bead comprising at least one annular reinforcing structure having a radially innermost point;
two sidewalls extending the beads radially outwards, the two sidewalls coming together in a crown comprising a crown reinforcement, radially surmounted by a tread;
a radial carcass reinforcement composed of thread reinforcing elements having an elongation at break EB_{C} and a breaking strength BS_{C}, placed at a placement pitch P_{C} and coated with rubber composition, the carcass reinforcement extending from one bead to the other, passing through the crown, the carcass reinforcement being anchored in each bead by a turn-up around the said at least one annular reinforcing structure, so as to form an outward strand and a return strand, the carcass reinforcement being designed so as to satisfy the inequality:
$$\frac{{BS}_{C}}{{P}_{C}} \leq 1.5 \cdot {10}^{6} \cdot \frac{( {R}_{S}^{2} - {R}_{E}^{2} )}{{R}_{T}} ,$$
where BS_{C} is expressed in newtons, R_{S} is the radial distance between the axis of rotation of the tire and the radially outermost point of the carcass reinforcement, R_{E} is the radial distance between the axis of rotation of the tire and the axial position where the tire reaches its maximum axial width, and R_{T} is the radial distance between the axis of rotation of the tire and the radially innermost point of the said at least one annular reinforcing structure, the placement pitch P_{C} and the radial distances R_{S}, R_{E} and R_{T} being expressed in metres;
each sidewall of the tire additionally comprising an additional strengthening reinforcement composed of thread reinforcing elements having an elongation at break EB_{A} and a breaking strength BS_{A}, placed at a placement pitch P_{A} and coated with a rubber composition, the additional strengthening reinforcement extending between a radially internal end occurring close to said at least one annular reinforcing structure of the bead which extends the sidewall and a radially external end located radially between the carcass reinforcement and the crown reinforcement,
in which EB_{A}, BS_{A}, P_{A}, EB_{C}, BS_{C} and P_{C} are chosen such that
$$\frac{{BS}_{A}}{{P}_{A}} \geq 1.3 \cdot \frac{{BS}_{C}}{{P}_{C}} , \\ and$$
$${EB}_{C} \geq {EB}_{A} ,$$
it being specified that the breaking strengths BS_{A} and BS_{C} and the elongations at break EB_{C} and EB_{A} are the corresponding values of the reinforcing elements before their incorporation in the tire,
said airtight layer being, at least in part, covered with a layer of self-sealing product.

2. The tire according to claim 1, wherein the crown reinforcement has, in each radial cross section, two axial ends and wherein the radially external end of each of the two additional strengthening reinforcements is axially inside the axial end of the closest crown reinforcement, the axial distance (DA) between the radially external end of each additional strengthening reinforcement and the axial end of the closest crown reinforcement being greater than or equal to 10 mm.

3. The tire according to claim 1, wherein the radially interior end of each additional strengthening reinforcement is radially inside the radially outermost point of the return strand of the carcass reinforcement and the radial distance between the radially interior end of each additional strengthening reinforcement and the radially outermost point of the return strand of the carcass reinforcement is greater than or equal to 10 mm.

4. The tire according to claim 1, wherein each additional strengthening reinforcement extends, in the bead, along the outward strand of the carcass reinforcement.

5. The tire according to claim 4, wherein the carcass reinforcement and the additional strengthening reinforcement each comprise at least one lap weld and wherein the weld of the carcass reinforcement is offset, in the circumferential direction, with respect to the weld of the additional strengthening reinforcement.

6. The tire according to claim 1, wherein each additional strengthening reinforcement extends, in the bead, along the return strand of the carcass reinforcement.

7. The tire according to claim 1, wherein the reinforcing elements of each additional strengthening reinforcement are oriented radially.

8. The tire according to claim 1, wherein the reinforcing elements of each additional strengthening reinforcement are inclined at an angle of between 40° and 80°, with respect to the radial direction.

9. The tire according to claim 1, wherein the reinforcing elements of the additional strengthening reinforcement are made of PET.

10. The tire according to claim 1, wherein the reinforcing elements of the additional strengthening reinforcement are aramid/nylon hybrid cords.

11. The tire according to claim 1, wherein the reinforcing elements of the additional strengthening reinforcement are cords made of aramid or aramid/PET hybrid cords.

12. The tire according to claim 1, wherein the layer of self-sealing product is positioned on the airtight layer facing the crown.

13. The tire according to claim 12, wherein said layer of self-sealing product extends over the airtight layer facing at least a portion of the said sidewalls, so that, in each sidewall, the radially innermost point of the layer of self-sealing product occurs radially inside the radially external end of the additional strengthening reinforcement.

14. The tire according to claim 1, wherein the layer of self-sealing product comprises at least (phr meaning parts by weight per hundred parts of elastomer) one thermoplastic stirene (“TPS”) elastomer and more than 200 phr of an extending oil for the said elastomer.

15. The tire according to claim 14, wherein the TPS is the predominant elastomer of the layer of self-sealing product.

16. The tire according to claim 1, wherein the TPS elastomer is selected from the group consisting of stirene/butadiene/stirene (SBS), stirene/isoprene/stirene (SIS), stirene/isoprene/butadiene/stirene (SIBS), stirene/ethylene/butylene/stirene (SEBS), stirene/ethylene/propylene/stirene (SEPS) and stirene/ethylene/ethylene/propylene/stirene (SEEPS) block copolymers and the mixtures of these copolymers.

17. The tire according to claim 16, wherein the TPS elastomer is selected from the group consisting of SEBS copolymers, SEPS copolymers and the mixtures of these copolymers.

18. The tire according to claim 14, wherein the layer of self-sealing product comprises at least (phr meaning parts by weight per hundred parts of solid elastomer):
(a) as predominant elastomer, an unsaturated diene elastomer;
(b) between 30 and 90 phr of a hydrocarbon resin;
(c) a liquid plasticizer, the Tg (glass transition temperature) of which is less than −20° C., at a content by weight of between 0 and 60 phr; and
(d) from 0 to less than 120 phr of a filler.

19. The tire according to claim 18, wherein the unsaturated diene elastomer is selected from the group consisting of polybutadienes, natural rubber, synthetic polyisoprenes, butadiene copolymers, isoprene copolymers and the mixtures of such elastomers.

20. The tire according to claim 19, wherein the unsaturated diene elastomer is an isoprene elastomer.

21. The tire according to claim 19, wherein the unsaturated diene elastomer is a blend of at least two solid elastomers, a polybutadiene or butadiene copolymer elastomer, referred to as “elastomer A”, and a natural rubber or synthetic polyisoprene elastomer, referred to as “elastomer B”, the elastomer A:elastomer B ratio by weight being within a range from 10:90 to 90:10.

22. The tire according to claim 21, wherein the elastomer A:elastomer B ratio by weight is within a range from 20:80 to 80:20.

23. The tire according to claim 18, wherein, comprising from 0 to less than 100 phr of filler, including from 0 to less than 15 phr of reinforcing filler.

24. The tire according to claim 18, comprising from 0 to 70 phr of filler, including from 0 to less than 5 phr of reinforcing filler.

25. The tire according to claim 18, comprising from 5 to 70 phr of filler other than a reinforcing filler.

26. The tire according to claim 18, additionally comprising a crosslinking agent comprising sulphur or a sulphur donor.

27. The tire according to claim 26, wherein the sulphur donor is a thiuram polysulphide, preferably tetrabenzylthiuram disulphide (TBzTD).
